(19) United States
(12) Patent Application Publication
(10) Pub. No.: US 2010/0037889 A1
(43) Pub. Date: Feb. 18, 2010

(54) SOLAR HEATING SYSTEM WITH BACK-UP HEATING

(75) Inventors: Michael W. Gordon, Grand Rapids, MI (US); Wade W. Bernreuter, Lowell, MI (US)

Correspondence Address: RATNERPRESTIA, P.O. BOX 980, VALLEY FORGE, PA, 19482, US

(73) Assignee: Bradford White Corporation, Ambler, PA (US)

(21) Appl. No.: 12/331,013

(22) Filed: Dec. 9, 2008

Related U.S. Application Data
(63) Continuation-in-part of application No. 12/189,943, filed on Aug. 12, 2008.

(51) Int. Cl. F24J 2/42; F24H 9/20; G05D 23/00

(52) U.S. Cl. 126/615; 122/14.21; 126/611; 700/300

(57) ABSTRACT

A water heater is disclosed. The water heater includes a water storage tank and a heat source positioned to heat water within the water storage tank. A heat exchanger is positioned within the bottom end portion of the water storage tank. The heat exchanger is configured to contain a fluid medium for heat exchange with water in the bottom end portion of the water storage tank. A temperature sensor is positioned at an elevation above the heat exchanger for sensing a temperature of water within the tank. A control system is configured to selectively activate the heat source as a function of the water temperature sensed by the temperature sensor. The heat source can be either a heating element positioned within the water storage tank, or a burner positioned to deliver products of combustion into a flue positioned within the tank for heating water within the water storage tank.

### CROSS-REFERENCE TO RELATED APPLICATION

This application is a continuation-in-part application of U.S. patent application Ser. No. 12/189,943, filed Aug. 12, 2008, which is incorporated herein by reference in its entirety.

### FIELD OF THE INVENTION

The present invention relates to a water heating system of a water heater including a solar heating system and a back-up heat source.

### BACKGROUND OF THE INVENTION

This invention relates to a water heater for residential or commercial use having a primary heat source and a back-up heat source. In operation, the primary heat source heats a recirculating fluid medium which transfers heat to water in a storage tank. The back-up heat source heats the water within the storage tank when the primary heat source is insufficient. The primary heat source may operate by solar power, for example. The back-up heat source can be a burner or one or more electric heating elements, for example.

Water heaters having primary and back-up heat sources are known, such as those disclosed in U.S. Pat. Nos. 4,037,785, 4,545,365, 4,615,328, 5,660,165 and 6,142,216, which are all incorporated herein by reference in their entirety. While water heaters having primary and back-up heat sources are known, manufacturers continually strive to improve their efficiency, reliability and/or thermal performance.

### SUMMARY OF THE INVENTION

According to one aspect of the invention, a water heater is disclosed. The water heater includes a water storage tank and a heat source positioned to heat water within the water storage tank. A heat exchanger is positioned within the bottom end portion of the water storage tank. The heat exchanger is configured to contain a fluid medium for heat exchange with water in the bottom end portion of the water storage tank. A temperature sensor is positioned at an elevation above the heat exchanger for sensing a temperature of water within the tank. A control system is configured to selectively activate the heat source as a function of the water temperature sensed by the temperature sensor. The heat source can be either a heating element positioned within the water storage tank, or a burner positioned to deliver products of combustion into a flue positioned within the tank for heating water within the water storage tank.

According to another aspect of the invention, a system for heating water is disclosed. The system includes a water heater including a water storage tank, a flue positioned within the water storage tank and a burner positioned to deliver products of combustion into the flue for heating water within the water storage tank. A tank heat exchanger is positioned at least partially within the bottom end portion of the water storage tank. The tank heat exchanger is configured to contain a fluid medium for heat exchange with water in the bottom end portion of the water storage tank. A temperature sensor is positioned at an elevation above the tank heat exchanger for sensing a temperature of water within the water storage tank. A control system is configured to selectively activate the burner as a function of the water temperature sensed by the temperature sensor. The system further includes a solar collector fluidly coupled to the tank heat exchanger of the water heater for circulating the fluid medium through the tank heat exchanger.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a partial cross-sectional elevation view of an exemplary embodiment of a back-up water heating system installation comprising a dual element water heater and a solar heating system operatively coupled to the water heater.

FIG. 2 is an elevation view of water heater of FIG. 1, wherein the outer shell of the water heater is omitted and the internal components of the water tank assembly are shown in broken lines to indicate that those components are positioned within the interior of the water tank.

FIG. 3 is a top plan view of the water heater tank of FIG. 2.

FIG. 4 is an elevation view of the water heater of the water heating system installation of FIG. 1.

FIG. 5 is a top plan view of the water heater of FIG. 4.

FIG. 6 is an elevation view of the solar heating system of FIG. 1 according to aspects of this invention.

FIG. 7 is a schematic view of a control system of the water heating system installation of FIG. 1 according to aspects of this invention.

FIG. 8 is a partial cross-sectional elevation view of an exemplary embodiment of a back-up water heating system installation comprising a gas-fired water heater and a solar heating system operatively coupled to the water heater.

FIG. 9 is a schematic view of a control system of the water heating system installation of FIG. 8 according to aspects of this invention.

### DETAILED DESCRIPTION OF THE DRAWINGS

Exemplary features of selected embodiments of this invention will now be described with reference to the figures. It will be appreciated that the spirit and scope of the invention is not limited to the embodiments selected for illustration. Also, it should be noted that the drawings are not rendered to any particular scale or proportion. It is contemplated that any of the exemplary configurations and materials and sizes described hereafter can be modified within the scope of this invention.

Referring generally to the figures and according to one aspect of the invention, a water heater 15, 115 is disclosed. The water heater 15, 115 includes a water storage tank 22, 122 and a heat source 32, 128 positioned to heat water within the water storage tank 22, 122. A heat exchanger 13, 113 is positioned within the bottom end portion of the water storage tank 22, 122. The heat exchanger 13, 113 is configured to contain a fluid medium for heat exchange with water in the bottom end portion of the water storage tank 22, 122. A temperature sensor 33′, 132′ is positioned at an elevation above the heat exchanger 13, 113 for sensing a temperature of water within the tank 22, 122. A control system 60, 160 is configured to selectively activate the heat source 32, 128 as a function of the water temperature sensed by the temperature sensor 33′, 132′. The heat source 32, 128 can be either a heating element 32 positioned within the water storage tank 22, or a burner 128 positioned to deliver products of combustion into a flue 126 positioned within the tank 122 for heating water within the water storage tank 22, 122.

According to another aspect of the invention, a system 110 for heating water is disclosed. The system includes a water heater 115 including a water storage tank 122, a flue 126 positioned within the water storage tank 122, and a burner 128 positioned to deliver products of combustion into the flue 126 for heating water within the water storage tank 122. A tank heat exchanger 113 is positioned at least partially within the bottom end portion of the water storage tank 122. The tank heat exchanger 113 is configured to contain a fluid medium for heat exchange with water in the bottom end portion of the water storage tank 122. A temperature sensor 132′ is positioned at an elevation above the tank heat exchanger 113 for sensing a temperature of water within the water storage tank 122. A control system 160 is configured to selectively activate the burner 128 as a function of the water temperature sensed by the temperature sensor 132′. The system further includes a solar collector 18 fluidly coupled to the tank heat exchanger 113 of the water heater 115 for circulating the fluid medium through the tank heat exchanger 113.

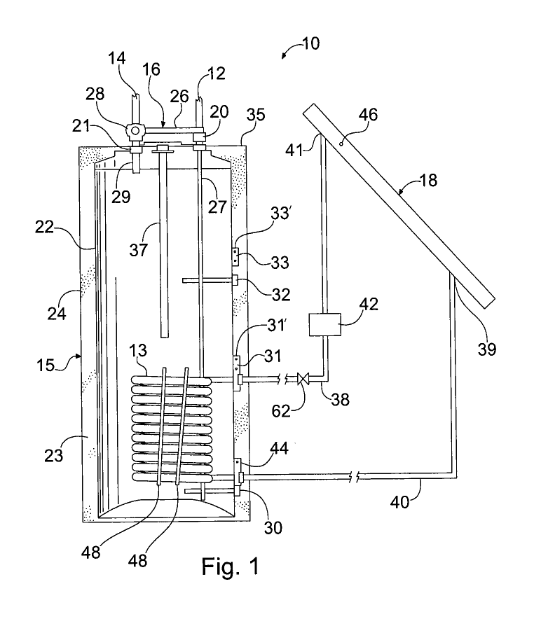

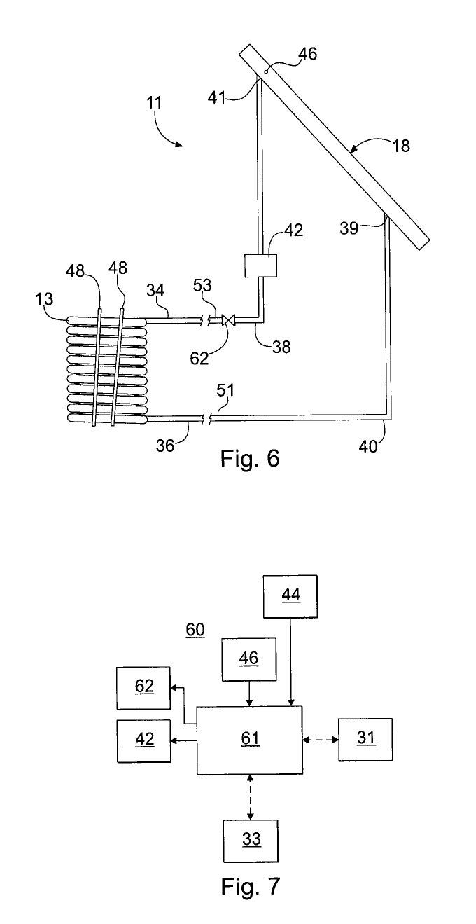

Referring now to FIG. 1 and FIG. 6, a residential or commercial back-up water heating system installation embodying exemplary aspects of this invention is generally designated by the numeral “10.” The back-up water heating system 10 (also referred to as “system 10” or “water heating system 10”) generally comprises an electric dual-element water heater 15 and a solar-powered heating system 11 for providing primary (or back-up) heating of water within the water heater 15. The water heater 15 generally includes a water tank 22 for storing water and two electrical heating elements 30 and 32 positioned within the water tank 22 for selectively heating water contained within the water tank 22. The water heater 15 may also be a single-element water heater.

The solar-powered heating system 11 generally includes a heat exchanger 13 positioned within a lower interior region of the water tank 22 that is fluidly coupled to a solar collector 18 positioned for exposure to sunlight. When sufficient solar energy is available, the fluid medium is circulated through the solar collector 18 where it is heated by sunlight. The heated fluid medium and is then distributed through the heat exchanger 13 for heating water contained within the water tank 22.

Referring now to FIGS. 1-5, the water heater 15 generally includes a water tank 22 for containing water, an outer shell 24 for encapsulating the water tank 22, and an annular cavity formed between the water tank 22 and the outer shell 24. By way of non-limiting example, the water tank 22 may hold 60, 75 or 115 gallons of water, for example. Foam insulation 23 is positioned in the annular cavity to limit the escapement of thermal energy from the water storage tank 22 to the surrounding environment. A top cover 35 is mounted at the top end of the outer shell 24 to substantially enclose the top end of the water tank 22. Foam insulation 23 may also be positioned between the top cover 35 and the top end of the water tank 22, as shown in FIG. 1.

The water heater 15 includes a cold water inlet port 20 at its top end. An inlet diptube 27 is coupled to the cold water inlet port 20 and extends to the bottom end of the water tank 22. As shown in FIG. 1, a cold water supply line 12 is attached (either directly or indirectly) to the cold water inlet port 20 to deliver cold water from a water source into the bottom end of the water tank 22 through the inlet dip tube 27.

A hot water outlet port 21 is also provided at the top end of the water heater 15. An outlet device 29 is coupled to the hot water outlet port 21 and extends to the top end of the water tank 22. By way of non-limiting example, the outlet device 29 may extend into the interior of the water tank by 1-inch, for example, as measured from the top end of the water tank 22. A hot water supply line 14 is attached (either directly or indirectly) to the hot water outlet port 21 to deliver hot water from the water tank 22 to one or more hot water distribution devices (not shown), such as a shower, a faucet, a clothes washer, or a dishwasher, for example.

A water tempering device 16 is optionally provided for improving the hot water supply performance of the water heater 15. The water tempering device 16 is generally configured to divert a portion of the cold water from the cold water supply line 12 to the hot water supply line 14 to deliver tempered water to the point(s) of use. The water tempering device 16 includes provisions for coupling to the cold water inlet port 20 of the water heater 15, the hot water outlet port 21 of the water heater 15, the hot water supply line 14, and the cold water supply line 12. The water tempering device 16 generally comprises a bypass conduit 26 for diverting a portion of the cold water from the cold water supply line 12 and a mixing device 28 that is configured to selectively mix the cold water with the hot water from the hot water outlet port 21. The tempered water is ultimately delivered from the mixing device 28 into the hot water supply line 14. A thermostatically controlled valve (not shown) is housed within the mixing device 28 and is configured to control the flow of fluid through the bypass conduit 26 as a function of the temperature setting of the thermostatically controlled valve. Further details of water tempering devices are described in U.S. patent application Ser. No. 11/904,107 to Gordon et al., which is incorporated by reference herein in its entirety.

A sacrificial anode 37 is coupled to the top of the water tank 22 to extend into the water tank 22. The sacrificial anode 37 is configured to limit or prevent corrosion of the metallic components within the water tank 22. Although not shown, another sacrificial anode may also be coupled to one end of the outlet device 29 to further enhance corrosion protection.

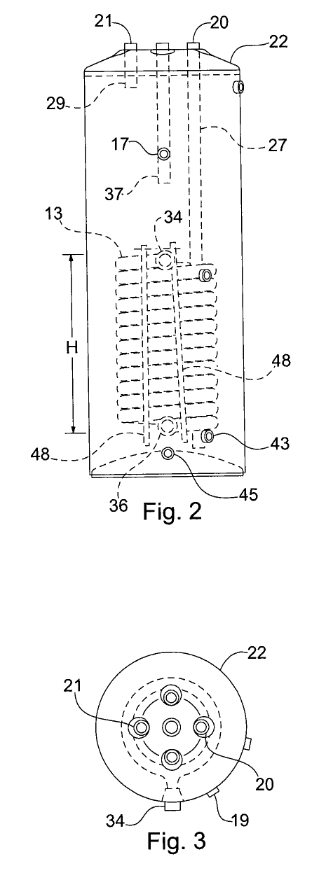

As best shown in FIG. 1, the water heater 15 includes two electrical heating elements 30 and 32 for heating water contained within the water tank 22. The upper electrical heating element 32 is positioned through an aperture 17 (see FIG. 2) provided in the wall of the water tank 22 at an elevation at or near the top end of the interior of the water tank 22. Accordingly, the upper electrical heating element 32 is positioned to heat the water at the top end of the water tank 22. Alternatively, the upper electrical heating element 32 may be positioned at or near the central interior portion of the water tank 22.

Operation of the upper electrical heating element 32 is controlled by a thermostat 33, which includes an internal temperature sensor 33′. The temperature sensor 33′ may be mounted to the exterior surface of the tank 22 for sensing the water temperature through the tank wall. The thermistor 33′ is optionally positioned at an elevation above the upper heating element 32 to sense the temperature of the water directly above the upper heating element 32. At a predetermined minimum temperature of the water adjacent the temperature sensor 33′, the thermostat 33 energizes the upper electrical heating element 32 to heat the water in the top end (or the central portion) of the water tank. The temperature sensor 33′ may be generally referred to herein as a thermistor, and, thus, is not limited to being provided in the form of a temperature sensor.

Because the outlet device 29 draws water from the top end of the water tank 22, as shown in FIG. 1, it is beneficial to position the upper thermostat 33 and the upper heating element 32 below and in the vicinity of the open end of the outlet device 29 to help ensure that hot water is continuously delivered to the end user. In operation, if the temperature of the water within the top end of the water tank 22 falls below a predetermined value, the upper thermostat 33 activates the upper heating element 32 to heat the water within the top end of the water tank 22.

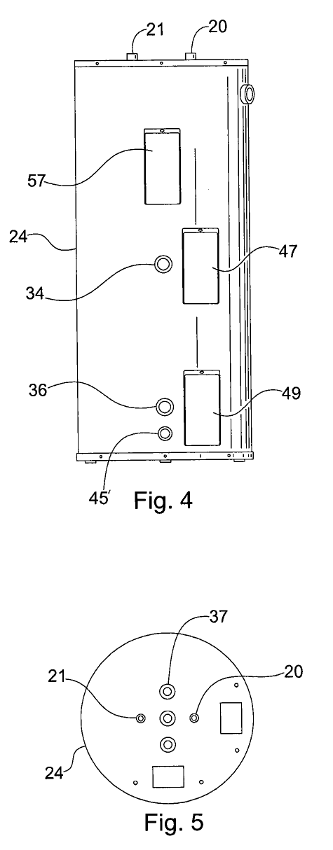

As shown in FIG. 4, a removable access panel 57 is positioned to conceal thermostat 33 and the upper electrical heating element 32. The access panel 57 may be removed for replacement, adjustment or repair the thermostat 33 and the upper electrical heating element 32.

The lower electrical heating element 30 is positioned through an aperture 43 (see FIG. 2) provided in the wall of the water tank 22 at an elevation at or near the bottom end of the water tank 22 for heating the water at the bottom end of the water tank 22. Operation of the lower electrical heating element 30 is controlled by a thermostat 31. Although not shown, the thermostat 31 includes a temperature sensor 31′ for sensing the temperature of the water within the water tank 22. The temperature sensor 31′ may be mounted to the exterior surface of the tank 22 for sensing the water temperature through the tank wall. At a predetermined minimum temperature of the water adjacent the temperature sensor 31′, the thermostat 31 energizes the lower electrical heating element 30 to heat the water in the bottom of the water tank 22. The temperature sensor 31′ may be generally referred to herein as a thermistor, and, thus, is not limited to being provided in the form of a temperature sensor.

As shown in FIG. 4, a removable access panel 47 is positioned to conceal the thermostat 31 and a removable access panel 49 is positioned to conceal the lower heating element 30. The access panels 47 and 49 may be removed for adjustment, replacement or repair of the thermostat 31 or the lower heating element 30.

According to the exemplary embodiment shown in FIG. 1, the water heater 15 includes electrical heating elements. As will be appreciated by those skilled in the art, the invention disclosed herein is not limited to electric water heaters. Many of the details of this invention may also apply to oil-fired water heaters, gas-fired water heaters or any other type of heat exchanger or insulated tank. Furthermore, although reference may be made to “residential” and “commercial” water heaters, the descriptions herein also apply to industrial or domestic water heaters as well as other heat transfer systems.

Referring still to FIG. 1, a thermistor 44 is mounted to the exterior wall of the water tank 22 for measuring a temperature of the water within the bottom end of the water tank 22. The purpose of the thermistor 44 will be described in greater detail with reference to FIG. 7. As shown in FIG. 4, the removable access panel 49 is positioned over the thermistor 44 the lower heating element 30 for installation, removal, replacement, adjustment or repair of those components. The thermistor 44 may be generally referred to herein as a temperature sensor, and, thus, is not limited to being provided in the form of a thermistor.

As shown in FIG. 2, a drain port 45 is provided in the bottom end of the water tank 22 for draining water stored within the water tank 22. An aperture 45′ (see FIG. 4) is provided in the outer shell 24 for providing access to the drain port 45. Although not shown, a valve may be coupled to the drain port 45 to selectively permit or prohibit the distribution of water from the water tank 22.

Referring still to FIG. 2, a heat exchanger 13 is positioned within the lower interior region of the water tank 22. The heat exchanger 13 is a coiled tube having a threaded coupling inlet end 34 and a threaded coupling outlet end 36. Both ends 34 and 36 are positioned through the tank wall 22 for fluidly coupling to the solar collector 18 (see FIG. 1). A height dimension “H” of the heat exchanger 13 is equal to or less than one-half of a height dimension of the water storage tank 22. The function and purpose of the heat exchanger 13 will be described in greater detail with reference hereinafter.

Referring now to FIGS. 1 and 6, the water heating system 10 includes a solar-powered heating system 11 that is adapted for selectively heating the water within the water tank 22. FIG. 1 depicts the entire water heating system 10 and FIG. 6 depicts the solar-powered heating system 11 by itself. The solar-powered heating system 11 generally includes the solar collector 18, the heat exchanger 13, two conduits 38 and 40 for fluidly coupling the solar collector 18 to the heat exchanger 13, a pump 42 for circulating a fluid medium through the foregoing components of the solar-powered heating system 11 and a valve 62 for permitting or prohibiting circulation of the fluid medium through the system 11.

General operation of the solar-powered heating system 11 is described hereinafter. In operation, a fluid medium is distributed through the solar collector 18 where, in the presence of sunlight, the fluid medium absorbs solar energy and increases in temperature. The fluid medium may comprise a water and glycol mixture, propylene glycol antifreeze, or any other fluid or refrigerant known in the art. The heated fluid medium is then delivered through conduit 38 and into the heat exchanger 13. The heated fluid medium heats the water within the bottom of the water tank 22. The fluid medium is then recirculated back to the solar collector 18 through the conduit 40 for reheating.

With reference now to the individual components of the solar-powered heating system 11, the heat exchanger 13 is positioned within the lower interior region of the water tank 22 and fluidly coupled to the solar collector 18. The heat exchanger 13 generally comprises a coiled tube defining an inlet end 34 for receiving the fluid medium and an outlet end 36 for distributing the fluid medium. The coils of the heat exchanger 13 are composed of a thermally conductive material, such as copper or glass lined steel, for example, to facilitate heat exchange between the water within the water tank 22 and the fluid medium carried within the coiled portion of the heat exchanger 13.

Referring now to FIGS. 1, 2, 3 and 6, the inlet end 34 of the heat exchanger 13 is fluidly coupled to the end 53 of the conduit 38 through the tank wall 22, such that the fluid medium is transferred from the conduit 38 and into the inlet end 34 of the heat exchanger 13. Similarly, the outlet end 36 of the heat exchanger 13 is fluidly coupled to the end 51 of the conduit 40 through the tank wall 22, such that the fluid medium is transferred from the outlet end 36 of the heat exchanger 13 and into the conduit 40.

Two coil spacing brackets 48 are optionally mounted to the coils of the heat exchanger 13. Each coil spacing bracket 48 is optionally welded to each individual coil to maintain spacing between adjacent coils of the heat exchanger 13 in an effort to reduce or eliminate noise caused by coil vibration. The coil spacing brackets 48 maximize the heat transfer surface area of each coil by preventing contact between adjacent coils. Another benefit of coil spacing brackets 48 is improved water circulation between adjacent coils, thereby decreasing stratification by permitting horizontal water flow during operation. The coil spacing brackets 48 may be mounted approximately 180 degrees apart to provide support for the heat exchanger 13 during shipping, handling and operation.

Unlike the heat exchanger disclosed in U.S. Pat. No. 5,660,165, the heat exchanger 13 embodiment shown in FIG. 1 is sized to fit within the lower interior region of the water tank 22. According to one aspect of the invention, the heat exchanger 13 is isolated within the lower interior region of the tank 22 where the greatest potential for heat transfer between the fluid medium within the heat exchanger 13 and the cold water in the lower interior region of the tank 22 exists. The lower interior region of the tank 22 typically contains the coldest water because cold water is distributed into the bottom end of the tank 22 via the inlet diptube 27 and heat naturally rises towards the top of the tank 22. By way of example, the heat exchanger 13 may be positioned in the lower-half of the water tank 22.

According to another aspect of the invention, the heat exchanger 13 is positioned at an elevation below the thermostat 31 such that the thermostat 31 can sense the rising heat transferred into the water tank 22 by the heat exchanger 13.

According to yet another aspect of the invention, the thermostat 31 is positioned at an elevation corresponding to about two-thirds of the height of the water tank (measured from the top end of the water tank) and a heat exchanger is positioned beneath the thermostat 31. More particularly, when a user draws at least about two-thirds of the water from the water tank 22 (typical water draw for a hot shower, for example), the thermostat 31 is optimally positioned at the aforementioned elevation to sense and respond to that hot water demand.

According to still another aspect of the invention, the heat exchanger 13 and the lower heating element 30 are positioned at an elevation below the lower thermostat 31. More particularly, by positioning the thermostat at an elevation corresponding to about two-thirds of the height of the water tank, a limited amount of vertical clearance exists below the thermostat 31 to accommodate both the heat exchanger 13 and the lower heating element 30. The lower heating element 30 is positioned at an elevation below the lower thermostat 31 such that the thermostat 31 can sense the rising heat transferred into the water tank 22 by the lower heating element 30. Additionally, the heat exchanger 13 is positioned at an elevation below the lower thermostat 31 for the aforementioned reasons. For those reasons, the heat exchanger 13 is positioned at an elevation between the lower thermostat 31 and the lower heating element 30. Alternatively, the lower heating element 30 may be positioned between the heat exchanger 13 and the lower thermostat 31.

Referring now to the solar collector 18 of the solar powered heating system 11, the solar collector 18 is a device configured to absorb incident solar radiation, convert the solar radiation to thermal energy, and to transfer the thermal energy to a fluid medium distributed through the body of the solar collector. Solar collectors are generally known in the art and described in greater detail in U.S. Pat. No. 5,794,611 to Bottum, which is incorporated herein by reference in its entirety. The solar collector 18 is optimally positioned outdoors for exposure to sunlight.

The solar collector 18 includes an inlet passage 39 for receiving the fluid medium, an internal passageway (not shown) that is exposed to the sunlight for heating the fluid medium and an outlet passage 41 for distributing the fluid medium from the solar collector 18. The inlet passage 39 is fluidly coupled to the conduit 40 and the outlet passage 41 is fluidly coupled to the conduit 38.

A thermistor 46 is positioned within the internal passageway of the solar collector 18 proximal to the outlet passage 41 of the solar collector 18. The thermistor 46 measures the temperature of the fluid medium prior to its delivery into the heat exchanger 13. The thermistor 46 may be generally referred to herein as a temperature sensor, and, thus, is not limited to being provided in the form of a thermistor. The purpose of the thermistor 46 will be explained in greater detail with reference to FIG. 7.

Conduits 38 and 40 fluidly couple the heat exchanger 13 to the solar collector 18 forming a continuous loop. The pump 42 is coupled to the conduit 38 (or conduit 40) for circulating the fluid medium through the solar-powered heating system 11. The pump 42 may be any commercially available pump. The valve 62 is coupled to the conduit 38 (or conduit 40) for permitting or prohibiting the flow of the fluid medium through the solar-powered heating system 11. In a closed positioned, the valve 62 limits or prevents the circulation of the fluid medium through the solar-powered heating system 11 and in the open position the valve 62 permits the circulation of the fluid medium through the solar-powered heating system 11. The valve 62 is an optional feature of the solar-powered heating system 11 and may be omitted.

In operation of the solar powered heating system 11, the pump 42 is activated and the valve 62 is maintained in an open state permitting the passage of fluid through the conduit 38. The pump 42 circulates the fluid medium through the inlet passage 39 of the solar collector 18. The fluid medium is then urged through the internal passageway of the solar collector 18 for solar heating. The heated fluid medium is ultimately expelled from the solar collector 18 through the outlet passage 41 and into the conduit 38. The conduit 38 delivers the heated fluid medium from the solar collector 18 to the heat exchanger 13. The fluid medium is expelled from the heat exchanger 13 through the conduit 40. The conduit 40 delivers the fluid medium back to the solar collector 18 for re-heating.

Thermal energy is transferred from the fluid medium to the water contained within the bottom end of the water tank 22 only when the water temperature at the bottom end of the water tank 22 is less than the temperature of the fluid medium within the solar collector 18. For that reason, the solar-powered heating system 11 is configured to operate only when heat transfer is possible, i.e., when the temperature of the water within the bottom end of the water tank 22 is less than the temperature of the fluid medium within the solar collector 18. Operation of the water heating system 10 is described in greater detail with reference to FIG. 7.

FIG. 7 depicts a schematic view of a control system 60 for operating the water heating system 10 of FIG. 1 according to aspects of this invention. Referring now to FIGS. 1, 6 and 7, the control system 60 is configured for operating the water heater 15 in concert with the solar-powered heating system 11. The control system 60 may include a controller including a processor, memory, and input/output functions. The control system 60 may be separate or incorporated with a control system (not shown) of the water heater 15.

The control system 60 is generally configured to maintain the temperature of the water within the water tank 22 at a substantially constant temperature to limit service disruptions to the end user. The control system 60 may maintain the water tank 22 at a substantially constant temperature by activating the solar-powered heating system 11, activating the upper heating element 32 and/or activating the lower heating element 30 depending upon the configuration of the entire water heating system 10. Those skilled in the art will understand that the control system 60 may be configured in a variety of different fashions to achieve a substantially constant water temperature and is not limited to any configuration described herein.

Any description of the operation of the water heating system 10 may also be supplemented by the solar water heating system operating guidelines published by the Solar Rating and Certification Corporation (SRCC). The SRCC OG-300 Solar Water Heating System Design and Installation Guidelines and the SRCC OG-100 Guidelines for Certifying Solar Collectors provide operating guidelines for operating solar water heating systems. SRCC OG-100 and SRCC OG-300 are incorporated by reference herein in their entirety.

As shown schematically in FIG. 7 and according to one aspect of the invention, the control system 60 receives a temperature value from the thermistor 46 corresponding to a temperature of the fluid medium stored within the solar collector 18. The control system 60 also receives a temperature value from the thermistor 44 corresponding to a temperature of the water within the bottom end of the water tank 22. The control system 60 is configured to selectively activate a pump 42 of the solar-powered heating system 11 as a function of the temperature values transmitted by the thermistors 46 and 44.

More particularly, if the temperature reported by thermistor 46 exceeds the temperature reported by thermistor 44 by more than a pre-determined value, the control system 60 activates the pump 42 to circulate the fluid medium through the heat exchanger 13 and the solar collector 18. Under this condition the temperature of the fluid medium is great enough to raise the temperature of the water contained within the bottom end of the water tank 22.

Conversely, if the temperature reported by thermistor 46 does not exceed the temperature reported by thermistor 44 by more than the pre-determined value, the control system 60 deactivates the pump 42 and the fluid ceases to circulate through the heat exchanger 13 and the solar collector 18. The control system 60 is also operatively connected to the valve 62 to discontinue circulation of the fluid medium through the solar-powered heating system 11. The control system 60 will turn off the pump 42 so that heat transfer fluid will not circulate unless needed. Such a valve is preferable where continued recirculation of the fluid medium below the pre-determined minimum temperature would result in system heat loss. The valve 62 is also preferable for servicing the heater. A properly located check valve will eliminate thermal siphoning. This circumstance occurs when the solar collector 18 is not exposed to a sufficient level of sunlight to heat the fluid medium to a level above the temperature of the water contained within the bottom end of the water tank 22. Continuing to operate the solar-powered heating system 11 under those conditions might actually remove heat from the water within the water tank 22.

According to another aspect of the invention, the control system is connected to the lower thermostat 31 of the water heater 15 such that the control system 60 controls the lower thermostat 31. It is contemplated that the control system 60 may deactivate the lower thermostat 31 (i.e., deactivating the lower heating element 30) when the solar-powered heating system 11 is operating. The connection between the control system 60 and the lower thermostat 31 is depicted by a broken line in FIG. 7 to indicate that the connection is an optional feature of the invention. Alternatively, a controller that is configured to heat the tank using solar energy is isolated from the control system 60.

According to yet another aspect of the invention, the control system 60 is optionally connected to the upper thermostat 33 of the water heater 15 such that the control system 60 also controls the upper thermostat 33. According to one exemplary use of the invention, the upper thermostat 33 may be energized while the solar-powered heating system 11 is operating.

According to still another aspect of the invention, both heating elements 30 and 32 may operate simultaneously to heat the water within the water tank 22. Thus, the water heater 15 can act as a standard dual heating element water heater when sufficient heat is required. According to one aspect of the invention, the upper heating element 32 has priority over the lower heating element 30, i.e., the upper heating element 32 will be activated prior to the lower heating element 30. This configuration serves two purposes. First, the water contained within the top portion of the water tank 22 will be heated prior to the water contained within the bottom portion of the water tank 22, since the water contained within the top portion of the water tank 22 is the first to be delivered to the end user. The second purpose is to provide more time for the solar collector 18 to absorb solar energy and transfer that energy to the fluid medium. Activating the upper heating element 32 alone might not raise the temperature of the water within the bottom end of the water tank significantly.

Under normal operating conditions, the solar-powered heating system 11 is the sole and primary water heat source. However, when solar power generated by the solar collector 18 cannot sufficiently heat the recirculating fluid medium to a predetermined minimum temperature, the temperature sensors 31′ and 33′ sense the temperature drop and the thermostats 31 and 33 actuate one or both of the electrical heating elements 30 and 32, which act as a back-up heat source. Thereafter, the water heater 15 operates as a standard dual-element electric water heater, at least until the temperature sensed by temperature sensors 31′ and 33′ rises above the predetermined minimum temperature at which time one or both of the heating elements 30 and 32 are deactivated. Accordingly, solar-powered heating system 11 is the primary heat source and the electrical heating elements 30 and 32 are a back-up or auxiliary heat source.

It is contemplated that the back-up heating system can be reversed so that the electrical heating elements 30 and 32 can act as a primary heat sources with the solar-powered heating system 11 acting as a back-up or supplemental heat source. Such a back-up water heating system may be appropriate in climates where solar energy may be insufficient to provide continuous hot domestic water needs but may at times be sufficient to supplement the water heater heat source.

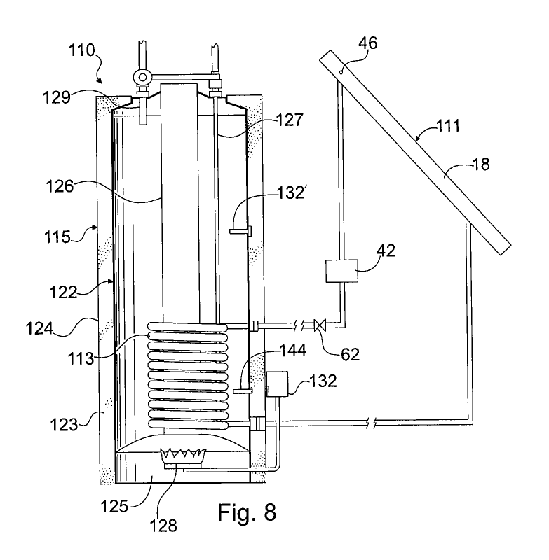

FIG. 8 depicts a residential or commercial back-up water heating system installation embodying exemplary aspects of this invention. The water heating system is generally designated by the numeral “110.” The back-up water heating system 110 (also referred to as “system 110” or “water heating system 110”) generally comprises a gas-fired water heater 115 and a solar-powered heating system 111 for providing primary (or back-up) heating of water within the water heater 115.

The solar-powered heating system 111 is substantially equivalent to the solar-powered heating system 11 of FIGS. 1 and 6. The water heater 115 is similar to the water heater 15 of FIGS. 1-5, with various exceptions. More particularly, the water heater 115 is gas-fired and does not include heating elements or thermostats that are configured to control operation of heating elements. Although water heater 115 is gas-fired, it is optionally oil-fired or fired using an alternative fuel. Description of the components that are common between the water heating system 110 and the water heating system 10 will be omitted.

The water heater 115 generally includes a water storage tank 122 for containing water, an outer shell 124 for encapsulating the water tank 122, and an annular cavity formed between the water tank 122 and the outer shell 124. Foam insulation 123 is positioned in the annular cavity to limit the escapement of thermal energy from the water storage tank 122 to the surrounding environment. A combustion chamber 125 is positioned at an elevation below the water storage tank 122. A flue 126 is positioned within a central region of the water storage tank 122 and extends the entire height of the tank 122. A burner 128 is positioned within the combustion chamber 125 to deliver products of combustion into the flue 126. Thermal energy is transferred from the products of combustion to the water within the water storage tank 122 through the wall of the flue 126. The flue 126 includes a lower opening that intersects the combustion chamber 125 to receive the products of combustion from the burner 128. Another opening is defined on the opposite end of the flue 126 for venting the products of combustion to ductwork (not shown). While the term “flue” generally refers to an exhaust conduit for combustion gases received from a combustion chamber of a fuel-fired water heater, the term “flue” herein refers to any structure capable of defining a passage for air.

The water heater 115 includes an adjustable gas control valve 132 that is attached to a gas supply line (not shown). The gas control valve 132 delivers gas to the burner 128 for combustion purposes. In operation, when the temperature sensed by the temperature sensor 132′ falls below a pre-set or pre-determined value, a control system of the water operator opens the gas control valve 132 to permit the delivery of gas to the burner 128. The burner 128 ignites the gas to deliver products of combustion into the flue 126 consequently raising the temperature of the water within the water tank 122. Once the water temperature reaches the pre-set or pre-determined value, as sensed by the temperature sensor 132′, the control system closes the gas control valve 132 (either directly or indirectly) and deactivates the burner 128.

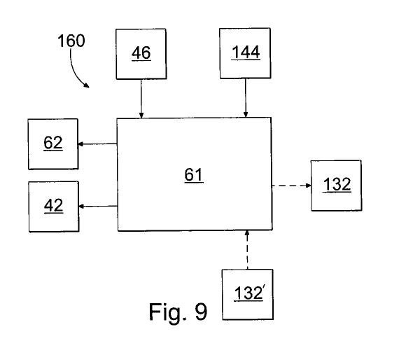

The aforementioned control system for controlling the gas control valve 132 may be the control system 160 schematically depicted in FIG. 9. Alternatively, the control system for controlling the gas control valve 132 may be a traditional water heater thermostat that receives temperature measurements from the temperature sensor 132′. As another alternative, the control system for controlling the gas control valve 132 may be a standard water heater controller (not shown) that receives temperature measurements from the temperature sensor 132′. The temperature sensor 132′ may be a thermistor, a thermocouple, or any other temperature measurement device known in the art.

The temperature sensor 132′ is positioned toward the top end of the water heater, at an elevation above the heat exchanger 113 and in the vicinity of the outlet device 129. Because the outlet device 129 draws water from the top end of the water tank 122, it is beneficial to position the temperature sensor 132′ at an elevation below and in the vicinity of the open end of the outlet device 129 to help ensure that hot water is continuously delivered to the end-user.

Another temperature sensor 144 is positioned at or above the bottom end of the heat exchanger 113 for sensing the water temperature at the bottom end of the water storage tank 122. The temperature sensor 144 may be provided in the form of a thermocouple that is at least partially positioned within the interior region of the tank 122, as shown in FIG. 8. The temperature sensor 144 may also be provided in the form of a thermistor mounted to the exterior wall of the tank 122. As another alternative, the temperature sensor 144 may be provided in the form of a thermostat.

As explained previously, the heat exchanger 113 is isolated within the lower interior region of the tank 122 where the greatest potential for heat transfer between the fluid medium within the heat exchanger 113 and the cold water in the lower interior region of the tank 122 exists. The temperature sensor 144 is positioned at or near the bottom end of the heat exchanger 113 to sense the temperature of the coldest water located at the lower interior region of the tank 122 and communicate that temperature to a control system, as described hereinafter with reference to FIG. 9.

As shown schematically in FIG. 9 and according to one exemplary embodiment of the invention, the water heating system 110 includes a control system 160 that is similar to the control system 60 of FIG. 7. In operation, the control system 160 receives a temperature value from the thermistor 46 corresponding to a temperature of the fluid medium stored within the solar collector 18. The control system 160 also receives a temperature value from the temperature sensor 144 corresponding to a temperature of the water within the bottom end of the water tank 122. The control system 60 is configured to selectively activate a pump 42 of the solar-powered heating system 111 as a function of the temperature values transmitted by the thermistor 46 and the temperature sensor 144.

More particularly, if the temperature reported by thermistor 46 exceeds the temperature reported by temperature sensor 144 by more than a pre-determined value (e.g., 5 degrees Fahrenheit), a controller 61 of the control system 160 activates the pump 42 to circulate the fluid medium through the heat exchanger 113 and the solar collector 18. Under this condition the temperature of the fluid medium is great enough to raise the temperature of the water contained within the bottom end of the water tank 122.

Conversely, if the temperature reported by thermistor 46 does not exceed the temperature reported by temperature sensor 144 by more than the pre-determined value, the controller 61 of the control system 160 deactivates the pump 42 (if the pump 42 was active) and the fluid ceases to circulate through the heat exchanger 113 and the solar collector 18. The control system 160 is also operatively connected to the valve 62 to discontinue circulation of the fluid medium through the solar-powered heating system 111.

The controller 61 receives temperature data from the temperature sensor 132′ that senses the temperature at the top end of the water tank 122. Once the water at the top end of the water tank 122 reaches a pre-determined minimum temperature, the controller 61 is configured to open the gas control valve 132 and actuate the burner 128 to heat the water within the water tank 122.

Thereafter, the water heater 115 operates as a standard gas-fired water heater, at least until the temperature sensed by temperature sensor 132′ rises above the predetermined minimum temperature at which time the gas control valve 132 is closed and the burner 128 is deactivated. Accordingly, solar-powered heating system 111 is the primary heat source and the burner 128 is a back-up or auxiliary heat source.

The connections between the control system 160 and the temperature sensor 132′ and the gas control valve 132 are depicted by broken lines in FIG. 9 to indicate that those connections are optional features of this embodiment of the invention. Those skilled in the art will recognize that various ways of configuring the water heating system 110 exist.

It is contemplated that the back-up heating system can be reversed so that the burner 128 can act as a primary heat source with the solar-powered heating system 111 acting as a back-up or supplemental heat source. Such a back-up water heating system may be appropriate in climates where solar energy may be insufficient to provide continuous hot domestic water needs but may at times be sufficient to supplement the water heater heat source.

According to the exemplary embodiment depicted in FIG. 8, the water heater 115 is gas-fired. As will be appreciated by those skilled in the art, the invention disclosed herein is not limited to gas-fired water heaters. Many of the details of this invention may also apply to oil-fired water heaters, or any other type of heat exchanger or insulated tank.

Although this invention has been described with reference to exemplary embodiments and variations thereof, it will be appreciated that additional variations and modifications can be made within the spirit and scope of this invention. Although this invention may be of particular benefit in the field of residential water heaters, it will be appreciated that this invention can be beneficially applied in connection with commercial or domestic water heaters and other heating systems as well.

What is claimed:

1. A water heater comprising:
a water storage tank;
a flue positioned within the water storage tank;
a burner that is configured to combust gas and is positioned to deliver products of combustion into the flue for heating water within the water storage tank;
a gas control valve that is configured to selectively deliver gas to the burner for combustion;
a heat exchanger positioned at least partially within the bottom end portion of the water storage tank, said heat exchanger being configured to contain a fluid medium for heat exchange with water in the bottom end portion of the water storage tank; and
a temperature sensor positioned at an elevation above the heat exchanger for sensing a temperature of water within the water storage tank, the gas control valve being configured to selectively deliver gas to the burner for combustion as a function of the water temperature sensed by the temperature sensor.

2. The water heater of claim 1, wherein the heat exchanger comprises a tube having two ends and a fluid passageway defined between the two ends for containing the fluid medium.

3. The water heater of claim 2, wherein the tube of the heat exchanger is coiled and is positioned to surround the flue.

4. The water heater of claim 2, said ends of said heat exchanger being configured to be operatively coupled to a solar heat exchanger positioned outside of the water storage tank.

5. The water heater of claim 4 further comprising:
another temperature sensor positioned at an elevation at or below the heat exchanger for measuring a temperature of the water within the water storage tank; and
a control system configured to compare the temperature sensed by another temperature sensor with a temperature of the fluid medium contained within the solar heat exchanger.

6. The water heater of claim 1, wherein a height dimension of the heat exchanger is equal to or less than one-half of a height dimension of the water storage tank.

7. The water heater of claim 1 further comprising an inlet diptube coupled to the water storage tank and positioned to deliver cold water into the bottom end portion of the water storage tank.

8. The water heater of claim 7, the inlet diptube being positioned to deliver cold water into the bottom end portion of the water storage tank at an elevation beneath the heat exchanger.

9. The water heater of claim 1 further comprising:
an inlet port positioned on the water storage tank for receiving cold water delivered from a cold water supply line;
an outlet port positioned on the water storage tank for distributing hot water from the water storage tank toward a hot water supply line; and
a water tempering device coupled to both the inlet port and to the outlet port for diverting a portion of the cold water from the cold water supply line to the hot water supply line, wherein the water tempering device is configured to selectively mix the cold water with the hot water for delivery of the mixed water into the hot water supply line.

10. A system for heating water comprising:
a water heater including
a water storage tank;
a flue positioned within the water storage tank;
a burner that is configured to combust gas and is positioned to deliver products of combustion into the flue for heating water within the water storage tank;
a gas control valve being configured to selectively deliver gas to the burner for combustion;
a tank heat exchanger positioned at least partially within the bottom end portion of the water storage tank, said tank heat exchanger being configured to contain a fluid medium for heat exchange with water in the bottom end portion of the water storage tank;
a temperature sensor positioned at an elevation above the tank heat exchanger for sensing a temperature of water within the water storage tank, said gas control valve being configured to selectively deliver gas to the burner for combustion as a function of the water temperature sensed by the temperature sensor; and
a solar collector fluidly coupled to the tank heat exchanger of the water heater for circulating the fluid medium through the tank heat exchanger.

11. The system of claim 10 further comprising a pump for circulating the fluid medium through the tank heat exchanger and the solar collector.

12. The system of claim 10 further comprising a tank temperature sensor positioned at the bottom end portion of the water storage tank for sensing a temperature of water within the bottom end portion of the water storage tank.

13. The system of claim 12, wherein the tank temperature sensor is positioned at an elevation at or above a bottom end of the tank heat exchanger.

14. The system of claim 12 further comprising:
a solar temperature sensor positioned on a surface of the solar heat exchanger for sensing a temperature of the fluid medium within the solar heat exchanger; and
a control system for comparing the temperatures sensed by the tank temperature sensor and the solar temperature sensor.

15. The system of claim 14, wherein the control system is configured to circulate the fluid medium through the solar heat exchanger and the tank heat exchanger when a difference between the temperatures sensed by the tank temperature sensor and the solar temperature sensor meets or exceeds a pre-determined level.

16. The system of claim 10, said water heater further comprising:
an inlet port positioned on the water storage tank for receiving cold water delivered from a cold water supply line;
an outlet port positioned on the water storage tank for distributing hot water from the water storage tank toward a hot water supply line; and
a water tempering device coupled to both the inlet port and to the outlet port for diverting a portion of the cold water from the cold water supply line to the hot water supply line, wherein the water tempering device is configured to selectively mix the cold water with the hot water for delivery of the mixed water into the hot water supply line.

17. A water heater comprising:
a water storage tank;
a heat source positioned to heat water within the water storage tank;
a heat exchanger positioned within the bottom end portion of the water storage tank, said heat exchanger being configured to contain a fluid medium for heat exchange with water in the bottom end portion of the water storage tank;
a temperature sensor positioned at an elevation above the heat exchanger for sensing a temperature of water within the water storage tank; and
a control system configured to selectively activate the heat source as a function of the water temperature sensed by the temperature sensor.

18. The water heater of claim 17 further comprising a flue positioned within the water storage tank, wherein the heat source comprises a burner that is configured to combust gas and is positioned to deliver products of combustion into the flue for heating water within the water storage tank.

19. The water heater of claim 17 wherein the heat source comprises a heating element positioned within a bottom end portion of the water storage tank for heating water within the bottom end portion of the water storage tank.
